(19) United States
(12) Patent Application Publication
(10) Pub. No.: US 2019/0087221 A1
(43) Pub. Date: Mar. 21, 2019

(54) THREAD PROCESSOR AND THREAD PROCESSING METHOD

(71) Applicant: BEIJING QIHOO TECHNOLOGY COMPANY LIMITED, Beijing (CN)

(72) Inventors: Han YAN, Beijing (CN); Xin RAN, Beijing (CN); Zhihui LIANG, Beijing (CN)

(21) Appl. No.: 15/741,133

(22) PCT Filed: Oct. 31, 2016
(86) PCT No.: PCT/CN2016/104062

§ 371 Date: Dec. 29, 2017

(30) Foreign Application Priority Data
Aug. 31, 2016 (CN) 201610797409.X

(51) Int. Cl. G06F 9/48; G06F 9/38; G06F 9/52; G06F 9/50

(52) U.S. Cl. CPC G06F 9/485; G06F 9/38; G06F 9/5016; G06F 9/5055; G06F 9/52

(57) ABSTRACT

The present invention discloses a thread processor and a thread processing method. The thread processor implements processing of a Linux thread based on a Windows system and comprises: a thread function converting module, configured to convert a processing function of a Linux thread to a processing function of a corresponding Windows thread by resolving the processing function of the Linux thread; a thread data structure converting module, configured to convert a data structure applicable to the Linux thread to a data structure applicable to the corresponding Windows thread by resolving the data structure of the Linux thread; and a thread blocking management module, configured to process blocking of a Windows thread by performing a cyclic detection on the Windows thread running in the Windows system by means of a function conversion and a data structure conversion.

### FIELD OF TECHNOLOGY

The present invention relates to the field of computer software technologies, and in particular, to a thread processor and a thread processing method, a computer program and a computer-readable medium.

### BACKGROUND

With popularization of mobile terminals installed with Android operating systems, more and more Android applications applied to the mobile terminals installed with Android operating systems thereupon appear on the application market. These Android applications greatly meet users' demands for life, entertainment and shopping, etc. However, due to limitations of mobility characteristics such as portability, the mobile terminals have problems of smaller screens, heat-prone processors, poor battery endurance ability and unstable network signal or the like, which may cause poor user visual experience and may cause interrupted or sluggish operation when in use. For this reason, a user may solve the above problems by running Andriod applications using a personal computer (PC) installed with a Windows system.

It may be implemented that the Andriod applications run on the PC installed with the Windows system by installing an Andriod virtual machine on the PC installed with the Windows system and by virtually running the Android operating system in the Andriod virtual machine, so that the user may have a better visual experience on a larger display screen and improve a running speed. However, because running of the Andriod virtual machine needs to consume a lot of hard-disk space and memory of the run, to a certain extent, this manner may affect a speed of running the Andriod applications on the PC.

The Andriod applications include processing many Linux system threads. When running the Andriod applications on the Windows system, processing of the Linux threads also may need to be implemented. A Windows thread is different from a Linux thread in running processing mechanism. Therefore, a processor or processing method for processing a Linux thread by the Windows system is needed. However, in the prior art there is no such a processor or processing method for processing a Linux thread by the Windows system.

### SUMMARY

In view of the aforementioned problems, the present invention is proposed to provide a thread processor and a thread processing method for overcoming the aforementioned problems or at least in part solving the aforementioned problems.

According to an aspect of the present invention, there is provided a thread processor for implementing processing of a Linux thread based on a Windows system, wherein the thread processor comprises:

a thread function converting module, configured to convert a processing function of a Linux thread to a processing function of a corresponding Windows thread by resolving the processing function of the Linux thread;

a thread data structure converting module, configured to convert a data structure applicable to the Linux thread to a data structure applicable to the corresponding Windows thread by resolving the data structure of the Linux thread; and

a thread blocking management module, configured to process blocking of a Windows thread by performing a cyclic detection on the Windows thread running in the Windows system by means of a function conversion and a data structure conversion.

According to another aspect of the present invention, there is provided a thread processing method for implementing processing of a Linux thread based on a Windows system, wherein the method comprises:

a step of thread function conversion: converting a processing function of a Linux thread to a processing function of a corresponding Windows thread by resolving the processing function of the Linux thread;

a step of thread data structure conversion: converting a data structure applicable to the Linux thread to a data structure applicable to the corresponding Windows thread by resolving the data structure of the Linux thread; and

a step of thread blocking management: processing blocking of a Windows thread by performing a cyclic detection on the Windows thread running in the Windows system by means of a function conversion and a data structure conversion.

According to the thread processor and the thread processing method provided by the present invention, the thread function converting module is executed to convert a processing function of a Linux thread to a processing function of a corresponding Windows thread by resolving the processing function of the Linux thread. The thread data structure converting module is executed to convert a data structure applicable to the Linux thread to a data structure applicable to the corresponding Windows thread by resolving the data structure of the Linux thread. The thread blocking management module is executed to process blocking of a Windows thread by performing a cyclic detection on the Windows thread running in the Windows system by means of a function conversion and a data structure conversion. It is implemented to process a Linux thread on a Windows system, and an effect of running the Linux thread on the Windows system is equivalent to that of running the Linux thread on a Linux system, thereby providing great convenience for running Andriod applications on the Windows system. Compared with installing an Andriod virtual machine on the Windows system, occupancy of system resources is greatly reduced, it is unnecessary for a user to execute a complicated installation operation, and better use experience is provided for the user.

Described above is merely an overview of a technical solution of the present invention. In order to more apparently understand the technical means of the present invention to implement in accordance with the contents of specification, and to more readily understand above and other objectives, features and advantages of the present invention, specific embodiments of the present invention are provided hereinafter.

### BRIEF DESCRIPTION OF THE DRAWINGS

Through reading the detailed description of the following preferred embodiments, various other advantages and benefits will become apparent to those of ordinary skills in the art. Accompanying drawings are merely included for the purpose of illustrating the preferred embodiments and should not be considered as limiting of the present invention. Further, throughout the drawings, like reference signs are used to denote like elements. In the drawings:

FIG. 1 is a functional block of a thread processor according to an embodiment of the present invention;

FIG. 2 is a functional block of a thread processor according to another embodiment of the present invention;

FIG. 3 is a flowchart of a thread processing method according to an embodiment of the present invention;

FIG. 4 is a flowchart of a thread processing method according to another embodiment of the present invention;

FIG. 5 is a block diagram of a computing device for executing the thread processing method according to the present invention; and

FIG. 6 is a memory cell for maintaining or carrying a program code for implementing the thread processing method according to the present invention.

### DESCRIPTION OF THE EMBODIMENTS

Exemplary embodiments of the present invention will be described in detail with reference to the accompanying figures hereinafter. Although the exemplary embodiments of the present invention are illustrated in the accompanying figures, it should be understood that the present invention may be embodied in many different forms and should not be construed as being limited to the embodiments set forth herein. Rather, these embodiments are provided so that this present invention will be understood thoroughly and completely and will fully convey the scope of the present invention to those skilled in the art.

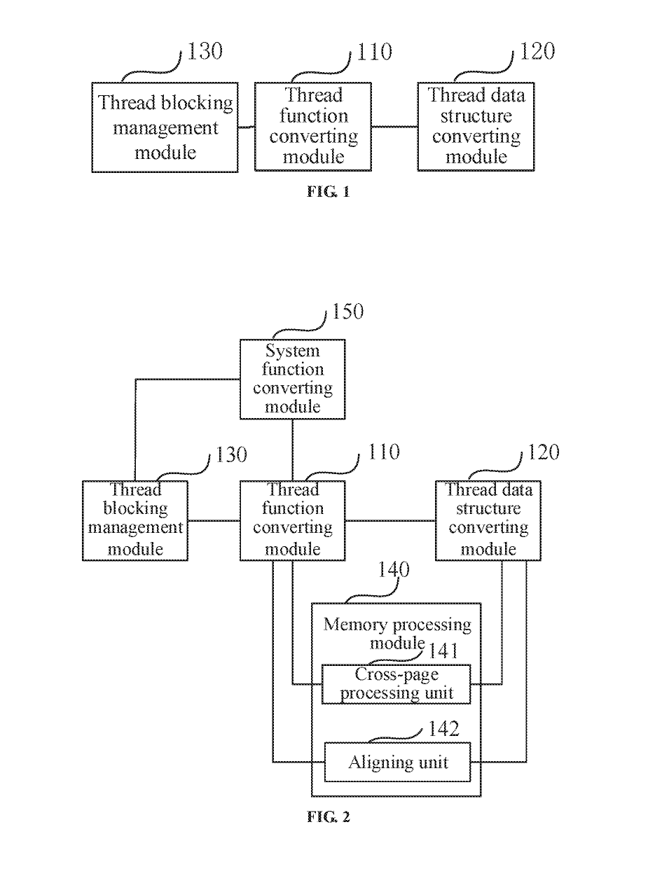

FIG. 1 is a functional block of a thread processor according to one embodiment of the present invention. The thread processor implements processing of a Linux thread based on a Windows system, as shown in FIG. 1, the thread processor specifically includes following modules.

A thread function converting module 110, configured to convert a processing function of a Linux thread to a processing function of a corresponding Windows thread by resolving the processing function of the Linux thread.

What are invoked in the Linux thread are various functions applicable to the Linux system. These functions cannot be directly executed on the Windows system, and functions implemented by these functions need to be converted by the thread function converting module 110. During conversion, the thread function converting module 110 may use functions applicable to the Windows system for corresponding function replacement.

After resolving the processing function of the Linux thread, the thread function converting module 110 needs to find out functions used by the Windows thread corresponding to one or more functions implementing the processing function of the Linux thread, and to invoke the functions used by the corresponding Windows thread in sequence according to an invoking sequence or processing sequence of functions in the Linux thread. When there is no function, in the Windows system, corresponding to one or more functions implementing the processing function of the Linux thread, the thread function converting module 110 also needs to complete corresponding implementation of the functions of the one or more functions on the Windows system, and to invoke the implementation function and other corresponding functions used by the Windows thread according to an invoking sequence or processing sequence of functions in the Linux thread. For example, a certain Linux thread A, wherein the Linux thread A includes invoking Function A1, Function A2 and Function A3. The thread function converting module 110 invokes Function B1, Function B2 and Function B3 in the corresponding Windows system. The Function B1 implements functions in the Function A1, the Function B2 implements functions in the Function A2, and the Function B3 implements functions in the Function A3. Alternatively, the Function B2 implements the functions in the Function A2 and the Function A3, and the thread function converting module 110 merely invokes the corresponding Function B1 and Function B2 in the Windows system. Alternatively, when in the Windows system there is no method corresponding to the functions implemented by the Function A1, the thread function converting module 110 needs to implement the functions implemented by the Function A1, and also needs to further invoke the corresponding method implementing the functions in the Function A2 and the Function A3 in the Windows system after implementing the functions corresponding to the Function A1.

Further, when the thread function converting module 110 invokes a corresponding function of the Windows thread, attention needs to be paid to a parameter invoked in the function, and the correct parameter is transferred so that the function of the Windows thread is invoked. When the parameter invoked by the function in the Windows thread is inconsistent with a parameter invoked by a function of the Linux thread, the parameter invoked by the function of the Linux thread needs to be converted to the parameter applicable to be invoked by the function in the Windows thread. Specifically the conversion needs to be based on actual situations. For example, the parameter invoked by the function of the Linux thread is processed so that the parameter applicable to be invoked by the function in the Windows thread is obtained therefrom. Alternatively, the parameter applicable to be invoked by the function in the Windows thread is obtained from the system, etc.

Meanwhile, a global variable in the thread and a static variable defined in the function are shared variables accessible to each thread. Therefore, thread local storage (TLS) is also involved in the thread. When it is needed a variable that is accessible to a thread for various function invocation but inaccessible to other threads, this needs to be implemented by the TLS. The Linux thread and the Windows thread respectively have a TLS, the data structures and the invocation functions of the two TLSs are different. Therefore, the thread function converting module 110 also needs to convert the TLS of the Linux thread to the TLS of the Windows thread. When the global variables of the Linux thread and the Windows thread are involved, the thread function converting module 110 also needs to invoke the global variables. The global variable of the Linux thread is saved in the TLS of the Linux thread, the global variable of the Windows thread is saved in the TLS of the Windows thread, and the thread function converting module 110 needs to convert the TLS of the Linux thread to the TLS of the Windows thread so as to ensure that change of the global variable in the Linux thread is correspondingly implemented in the Windows thread.

For the parameter, it is also needed to note that a parameter push stack in the Linux thread is different from that in the Windows thread. When acquiring the parameter in the Linux thread and transferring the parameter into the Windows thread, the thread function converting module 110 also needs to conduct corresponding conversion according to difference in parameter push stack processing.

The above content is merely illustration, and the thread function converting module 110 needs to convert the processing function of the Linux thread to the processing function of the corresponding Windows thread according to the actual situations.

The above problem whether a data structure such as the parameter and the global variable in the Linux thread is applicable to the Windows thread is further processed by a thread data structure converting module 120.

The thread data structure converting module 120 is configured to convert a data structure applicable to the Linux thread to a data structure applicable to the corresponding Windows thread by resolving the data structure of the Linux thread.

The data structure used in the Linux thread is different from that used in the Windows thread. For example, a parameter data structure applicable to the Linux thread, or a data structure of TLS applicable to the Linux thread, etc.

After resolving the data structure of the Linux thread, the thread data structure converting module 120 converts the parameter data structure applicable to the Linux thread to the parameter data structure applicable to the corresponding Windows thread. For example, when a parameter invoked by a certain function in the Linux thread is a long type and a parameter invoked by a certain function in the Windows thread is a String type, the thread function converting module 110 may not directly transfer the long type parameter in the Linux thread to the function in the Windows thread for invocation. The thread data structure converting module 120 needs to convert the long type parameter to the String type parameter, after which the thread function converting module 110 transfers the converted String type parameter to the function in the Windows thread for invocation.

Further, when the number of parameters invoked by functions in the Linux thread is inconsistent with that of parameters invoked by functions in the Windows thread, the thread data structure converting module 120 also needs to convert the parameters invoked by the functions in the Linux thread to the parameters invoked by the functions in the Windows thread. When all the parameters invoked by the functions in the Windows thread are present in the parameters invoked by the functions in the Linux thread, the thread data structure converting module 120 only needs to convert the data structure of the parameter invoked by the function in the Windows thread to the data structure of the parameter invoked by the corresponding function in the Linux thread. And the thread function converting module 110 transfers the converted parameter invoked by the corresponding function in the Linux thread to the function in the Windows thread. When the parameters invoked by the functions in the Windows thread are absent from the parameters invoked by the functions in the Linux thread, first of all, the thread function converting module 110 converts the parameters invoked by the functions in the Linux thread, or obtains the parameters required for the functions in the Windows thread absent from the Linux thread through other means, then the thread data structure converting module 120 converts the data structures of all the parameters required in the Windows thread.

For the TLS, after resolving the data structure of the Linux thread, the thread data structure converting module 120 converts the TLS data structure applicable to the Linux thread to the TLS data structure applicable to the corresponding Windows thread. For example, for the data structures of the global variables stored in the TLS of the Linux thread and/or of the static variables defined in the functions, the thread data structure converting module 120 needs to convert them, one to one, to the data structures of the global variables stored in the TLS of the Windows thread and/or of the static variables defined in the functions.

A thread blocking management module 130, configured to process blocking of a Windows thread by performing a cyclic detection on the Windows thread running in the Windows system by means of a function conversion and a data structure conversion.

Thread blocking occurs in a thread execution process. Running of a thread is blocked due to some conditions, which causes the thread blocking. When the thread is in the blocking state, no CPU time is allocated to the thread, and no operation is executed until the thread reenters into a ready state. An infinite loop state is caused when two threads are invoked each other, which may cause that it is impossible to continue running either of the two threads. Therefore, the thread blocking needs to be managed so as to avoid deadlock, no response or the like which are caused by failure of timely execution of the thread.

The thread blocking management module 130 processes blocking of a Windows thread by performing a cyclic detection on the Windows thread in the Windows system. Reference is made respectively regarding to processing modes as below.

The thread blocking management module 130 creates an independent first intermediate thread which is used for cyclic detection of the Windows thread. For example, before performing response processing on the Windows thread, the first intermediate thread detects whether the Windows thread is blocked, and manages the Windows thread to execute the response processing when the Windows thread is not blocked. For example, the first intermediate thread detects whether the Windows thread meets an execution condition, and manages the Windows thread to execute the response processing when the Windows thread meets the execution condition. It is ensured that the unblocked Windows thread may rapidly execute the response processing.

Alternatively, the thread blocking management module 130 creates an independent second intermediate thread which is used for cyclic detection of the Windows thread. When the second intermediate thread detects that the Windows thread is blocked, first of all, the blocked Windows thread is paused, and stack information of the blocked Windows thread is stored in the second intermediate thread. Then the blocked Windows thread is forced to be not blocked any more and the response processing is executed. After the Windows thread executes the response processing, the blocked stack information in the Windows thread is recovered. Alternatively, when the second intermediate thread detects that the Windows thread is blocked, the blocked Windows thread is forced to be not blocked any more so that the Windows thread is continued to be executed. Methods for the compulsory execution may be set up according to the actual situations, such as simulating meeting the condition that the Windows thread is continued to be executed, which is not specifically limited herein.

Further, the Linux thread further includes signal processing but the Windows thread does not include signal processing. Therefore, the thread function converting module 110 also needs to conduct corresponding conversion processing when the signal of the Linux thread is invoked. For example, the signal may be processed as a certain triggering condition bound on the Windows thread. When the signal is invoked, namely when the triggering condition of the Windows thread is met, corresponding processing related to the signal is executed. The thread blocking management module 130 detects whether a signal on the Windows thread is invoked. When the signal is invoked, the Windows thread executes a related processing function corresponding to the invoked signal. When no signal on the Windows thread is invoked, the Windows thread comes into dormancy, and the dormancy time may be specified. Further, the thread blocking management module 130 may perform processing such as self-inspection, deadlock detection or the like on the Windows thread during the period of dormancy of the Windows thread.

According to the thread processor provided by the present invention, a processing function of a Linux thread is converted to a processing function of a corresponding Windows thread by resolving the processing function of the Linux thread. A data structure applicable to the Linux thread is converted to a data structure applicable to the corresponding Windows thread by resolving the data structure of the Linux thread. Blocking of the Windows thread is processed by performing a cyclic detection on the Windows thread running in the Windows system by means of a function conversion and a data structure conversion. It is implemented to process a Linux thread on a Windows system, and an effect of running the Linux thread on the Windows system is equivalent to that of running the Linux thread on a Linux system, thereby providing great convenience for running Andriod applications on the Windows system. Compared with installing an Andriod virtual machine on the Windows system, occupancy of system resources is greatly reduced, it is unnecessary for a user to execute a complicated installation operation, and better use experience is provided for the user. Meanwhile, by performing timely and effective processing on blocking of the Windows thread, it is solved the problem of memory occupied and slow running speed or the like caused by thread blocking or infinite loop, etc.

FIG. 2 is a functional block of a thread processor according to another embodiment of the present invention. As shown in FIG. 2, in addition to including the modules as shown in FIG. 1, the thread processor further includes a memory processing module 140 and a system function converting module 150.

The memory processing module 140 is configured to implement a storage function for storing the Linux thread to a Windows system memory and a search function. Specifically, since the Windows system and the Linux system have their own storage rules, when storing the Linux thread to the Windows system memory, the memory processing module 140 finds out free Windows memory space of consecutive addresses meeting the size requirements for the Linux thread and stores the Linux thread according to a Windows system memory storage rule. After the storing, the memory processing module 140 further provides a search function, and finds the Linux thread out from the Windows memory space according to a storage address of the Windows system memory.

The memory processing module 140 further includes a cross-page processing unit 141. When the memory processing module 140 stores the Linux thread, likely the Linux thread may only need one page of the Windows memory space or need more pages of the Windows memory space. When the Linux thread needs more pages of the Windows memory space, the cross-page processing unit 141 executes the cross-page processing. In other words, space required for the Linux thread exceeds one page of the Windows memory space in size. When the current page space of each page of the Windows memory space is insufficient to complete storage requirements for the Linux thread, namely when the current page space in the Windows system memory is insufficient, the cross-page processing unit 141 executes the cross-page processing according to a Windows system memory page management rule to complete memory allocation for the Windows system so as to implement the storage of the Linux thread. When the cross-page processing unit 141 executes the cross-page processing, also it is needed to mark allocated memory page space. For example, a usage state (already used address space, remaining address space size and so on) of memory page space, a permission of the memory page space, address information of each memory page space, a link sequence of each memory page space and so on are marked so that it is convenient to search the Linux thread subsequently.

The memory processing module 140 further includes an aligning unit 142, which is configured to perform alignment processing to achieve memory allocation for the Windows system according to a Windows system memory alignment rule when a current byte space of the Windows system memory is insufficient. For example, when an address offset requested by the Linux thread does not meet an alignment requirement for Windows bytes, this may likely cause that, during storage, it is impossible to implement exactly one-to-one or one-to-more storage for bytes of the Windows system and bytes requested by the Linux thread, which may cause that certain space is left after a part of contents of the Linux thread is stored in the bytes of the Windows system, and the left space is insufficient to continue completing the storage of the Linux thread. In this case, the aligning unit 142 executes the alignment processing and allocates the Windows system memory to complete the storage of the Linux thread. When the aligning unit 142 executes the alignment processing, it is also needed to mark allocated memory bytes. For example, a usage state (already used bytes, sizes of remaining bytes and so on) of memory bytes, a permission of the memory bytes, address information of each memory byte, a link sequence of each memory byte and so on are marked so that it is convenient to search the Linux thread subsequently.

A system function converting module 150, configured to convert a function of a Linux system function to a corresponding function of a Windows function. System functions used by the Linux thread are Linux system functions. When the Linux thread runs on the Windows system, it is needed to convert functions implemented by these Linux system functions to the corresponding functions of the Windows system functions. For example, the functions such as printf, strlen, fopen and so on under the Linux system are converted to the corresponding functions in win32 API under the Windows system. For example, when the Linux system functions have no corresponding Windows system functions in the Windows system, the system function converting module 150 also needs to reconstruct the Linux system functions in the Windows system so that they are implemented as functions applicable to the Windows system.

According to the thread processor provided by the present invention, storing and searching a Linux thread on a Windows system are completed, a Linux system function is converted to a corresponding Windows system function, so that an effect of running the Linux thread on the Windows system is equivalent to that of running the Linux thread on a Linux system, thereby providing great convenience for running Andriod applications on the Windows system. An unmodified binary level compatibility to the Linux thread is implemented.

FIG. 3 is a flowchart of a thread processing method according to an embodiment of the present invention. The method implements processing of a Linux thread based on a Windows system, as shown in FIG. 3, the thread processing method specifically includes following steps.

Step S11, a step of thread function conversion: converting a processing function of a Linux thread to a processing function of a corresponding Windows thread by resolving the processing function of the Linux thread.

What are invoked in the Linux thread are various functions applicable to the Linux system. These functions cannot be directly executed on the Windows system, and functions implemented by these functions need to be converted by executing the step of thread function conversion. During the conversion, functions applicable to the Windows system are used for corresponding function replacement.

After resolving the processing function of the Linux thread, it is needed to find out functions used by the Windows thread corresponding to one or more functions implementing the processing function of the Linux thread, and to invoke the corresponding functions used by the Windows thread in sequence according to an invoking sequence or processing sequence of functions in the Linux thread. When there is no function, in the Windows system, corresponding to one or more functions implementing the processing function of the Linux thread, it is also needed to complete corresponding implementation of the functions of the one or more functions on the Windows system, and to invoke the implementation function and other corresponding functions used by the Windows thread in sequence according to an invoking sequence or processing sequence of functions in the Linux thread. For example, a certain Linux thread A, wherein the Linux thread A includes invoking Function A1, Function A2 and Function A3. During the conversion, corresponding Function B1, Function B2 and Function B3 in the Windows system are invoked. The Function B1 implements functions in the Function A1, the Function B2 implements functions in the Function A2, and the Function B3 implements functions in the Function A3. Alternatively, the Function B2 implements the functions in the Function A2 and the Function A3, and during the conversion, merely the corresponding Function B1 and Function B2 in the Windows system are invoked. Alternatively, when in the Windows system there is no method corresponding to the functions implemented by the Function A1, it is also needed to implement the functions implemented by the Function A1, and to further invoke the corresponding method implementing the functions in the Function A2 and the Function A3 in the Windows system after implementing the functions corresponding to the Function A1.

Further, when invoking a corresponding function of the Windows thread, attention needs to be paid to a parameter invoked in the function, and the correct parameter is transferred so that the function of the Windows thread is invoked. When the parameter invoked by the function in the Windows thread is inconsistent with a parameter invoked by a function of the Linux thread, the parameter invoked by the function of the Linux thread needs to be converted to the parameter applicable to be invoked by the function in the Windows thread. Specifically the conversion needs to be based on actual situations. For example, the parameter invoked by the function of the Linux thread is processed so that the parameter applicable to be invoked by the function in the Windows thread is obtained therefrom. Alternatively, the parameter applicable to be invoked by the function in the Windows thread is obtained from the system, etc.

Meanwhile, a global variable in the thread and a static variable defined in the function are shared variables accessible to each thread. Therefore, thread local storage (TLS) is also involved in the thread. When it is needed a variable that is accessible to a thread for various function invocation but inaccessible to other threads, this needs to be implemented by the TLS. The Linux thread and the Windows thread respectively have a TLS, the data structures and the invocation functions of the two TLSs are different. Therefore, it is also needed to convert the TLS of the Linux thread to the TLS of the Windows thread. When the global variables of the Linux thread and the Windows thread are involved, attention needs to be paid to invoking the global variables. The global variable of the Linux thread is saved in the TLS of the Linux thread, the global variable of the Windows thread is saved in the TLS of the Windows thread, and during the conversion, the TLS of the Linux thread needs to be converted to the TLS of the Windows thread so as to ensure that change of the global variable in the Linux thread is correspondingly implemented in the Windows thread.

For the parameter, it is also needed to note that a parameter push stack in the Linux thread is different from that in the Windows thread. When acquiring the parameter in the Linux thread and transferring the parameter into the Windows thread, it is also needed to conduct corresponding conversion according to difference in parameter push stack processing.

The above content is merely illustration, and it is needed to convert the processing function of the Linux thread to the corresponding processing function of the Windows thread according to the actual situations.

The above problem whether a data structure such as the parameter and the global variable in the Linux thread is applicable to the Windows thread is further processed in Step S12.

Step S12, a step of thread data structure conversion: converting a data structure applicable to the Linux thread to a data structure applicable to the corresponding Windows thread by resolving the data structure of the Linux thread.

The data structure used in the Linux thread is different from that used in the Windows thread. For example, a parameter data structure applicable to the Linux thread, or a data structure of TLS applicable to the Linux thread, etc.

A parameter data structure applicable to the Linux thread is converted to a parameter data structure applicable to the corresponding Windows thread by resolving the data structure of the Linux thread. For example, when a parameter invoked by a certain function in the Linux thread is a long type and a parameter invoked by a certain function in the Windows thread is a String type, when executing Step S11, the long type parameter in the Linux thread may be not directly transferred to the function in the Windows thread for invocation. It is needed to convert the long type parameter to the String type parameter, after which Step S11 is executed to transfer the converted String type parameter to the function in the Windows thread for invocation.

Further, when the number of parameters invoked by functions in the Linux thread is inconsistent with that of parameters invoked by functions in the Windows thread, it is also needed to convert the parameters invoked by the functions in the Linux thread to the parameters invoked by the functions in the Windows thread. When all the parameters invoked by the functions in the Windows thread are present in the parameters invoked by the functions in the Linux thread, it is only needed to convert the data structure of the parameter invoked by the function in the Windows thread to the data structure of the parameter invoked by the function in the corresponding Linux thread, and then Step S11 is executed to transfer the converted parameter invoked by the corresponding function in the Linux thread to the function in the Windows thread. When the parameters invoked by the functions in the Windows thread are absent from the parameters invoked by the functions in the Linux thread, Step S11 is executed first to convert the parameters invoked by the functions in the Linux thread, or to obtain the parameters required for the functions in the Windows thread absent from the Linux thread through other means, then the data structures of all the parameters required in the Windows thread are converted.

For the TLS, after resolving the data structure of the Linux thread, the TLS data structure applicable to the Linux thread is converted to the TLS data structure applicable to the corresponding Windows thread. For example, for the data structures of the global variables stored in the TLS of the Linux thread and/or of the static variables defined in the functions, it is needed to convert them, one to one, to the data structures of the global variables stored in the TLS of the Windows thread and/or of the static variables defined in the functions.

When the above Step S11 and Step S12 are executed, as mentioned in the above examples, either Step S11 or Step S11 may be executed first likely. Specifically the execution is based on the actual situations, and a specific execution sequence is not set herein.

Step S13, a step of thread blocking management: processing blocking of a Windows thread by performing a cyclic detection on the Windows thread running in the Windows system by means of a function conversion and a data structure conversion.

Thread blocking occurs in a thread execution process. Running of a thread is blocked due to some conditions, which causes the thread blocking. When the thread is in the blocking state, no CPU time is allocated to the thread, and no operation is executed until the thread reenters into a ready state. An infinite loop state is caused when two threads are invoked each other, which may cause that it is impossible to continue running either of the two threads. Therefore, the thread blocking needs to be managed so as to avoid deadlock, no response or the like which are caused by failure of timely execution of the thread.

Therefore, blocking of a Windows thread is processed. Reference is made respectively regarding to processing modes as below.

The step of thread blocking management further includes creating an independent first intermediate thread which is used for cyclic detection of the Windows thread. For example, before performing response processing on the Windows thread, the first intermediate thread detects whether the Windows thread is blocked, and manages the Windows thread to execute the response processing when the Windows thread is not blocked. For example, the first intermediate thread detects whether the Windows thread meets an execution condition, and manages the Windows thread to execute the response processing when the Windows thread meets the execution condition. It is ensured that the unblocked Windows thread may rapidly execute the response processing.

Alternatively, the step of thread blocking management further includes creating an independent second intermediate thread which is used for cyclic detection of the Windows thread. When the second intermediate thread detects that the Windows thread is blocked, first of all, the blocked Windows thread is paused, and stack information of the blocked Windows thread is stored in the second intermediate thread. Then the blocked Windows thread is forced to be not blocked any more and the response processing is executed. After the Windows thread executes the response processing, the blocked stack information in the Windows thread is recovered. When the second intermediate thread detects that the Windows thread is blocked, the blocked Windows thread is forced to be not blocked any more so that the Windows thread is continued to be executed. Methods for the compulsory execution may be set up according to the actual situations, such as simulating meeting the condition that the Windows thread is continued to be executed, which is not specifically limited herein.

Further, the Linux thread further includes signal processing but the Windows thread does not include signal processing. Therefore, the thread function converting module 110 also needs to conduct corresponding conversion processing when the signal of the Linux thread is invoked. For example, the signal may be processed as a certain triggering condition bound on the Windows thread. When the signal is invoked, namely when the triggering condition of the Windows thread is met, corresponding processing related to the signal is executed. The step of thread blocking management further includes detecting whether a signal on the Windows thread is invoked. When the signal is invoked, the Windows thread executes a related processing function corresponding to the invoked signal. When no signal on the Windows thread is invoked, the Windows thread comes into dormancy, and the dormancy time may be specified. Further, processing such as self-inspection, deadlock detection or the like may be performed on the Windows thread during the period of dormancy of the Windows thread.

When no data structure conversion is involved in the Windows thread, namely when it is not needed to execute Step S12, Step S13 may be directly executed after Step S11. Step S13 also may be executed after executing Step S11 and Step S12. During specific execution, various steps need to be executed according to the actual situations, and the step execution sequence is not limited herein.

According to the thread processing method provided by the embodiments of the present invention, a processing function of a Linux thread is converted to a processing function of a corresponding Windows thread by resolving the processing function of the Linux thread. A data structure applicable to the Linux thread is converted to a data structure applicable to the corresponding Windows thread by resolving the data structure of the Linux thread. Blocking of the Windows thread is processed by performing a cyclic detection on the Windows thread running in the Windows system by means of a function conversion and a data structure conversion. It is implemented to process a Linux thread on a Windows system, and an effect of running the Linux thread on the Windows system is equivalent to that of running the Linux thread on a Linux system, thereby providing great convenience for running Andriod applications on the Windows system. Compared with installing an Andriod virtual machine on the Windows system, occupancy of system resources is greatly reduced, it is unnecessary for a user to execute a complicated installation operation, and better use experience is provided for the user. Meanwhile, by performing timely and effective processing on blocking of the Windows thread, it is solved the problem of memory occupied and slow running speed or the like caused by thread blocking or infinite loop, etc.

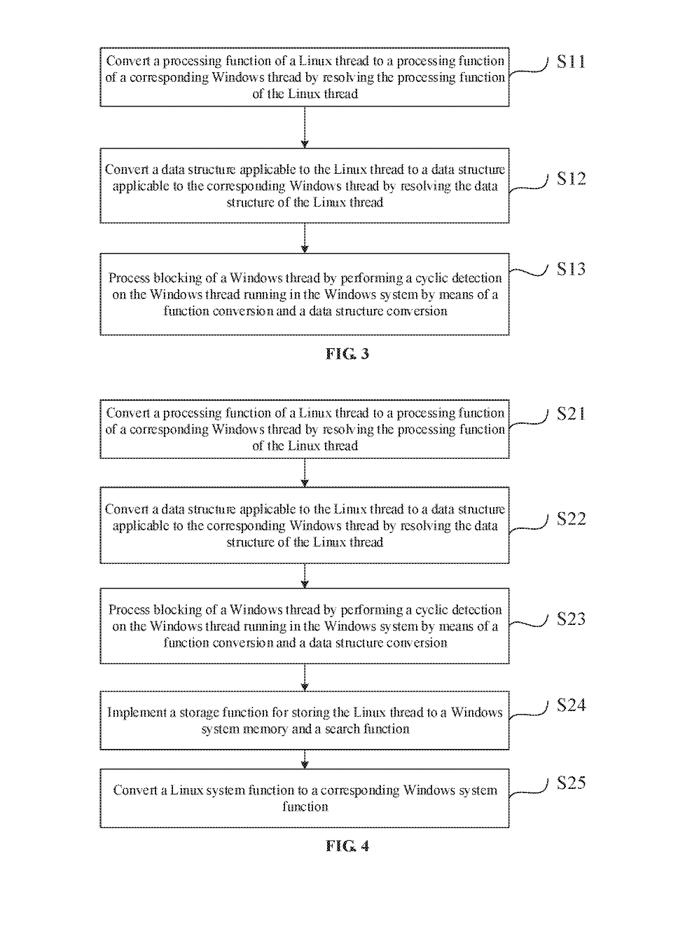

FIG. 4 is a flowchart of a thread processing method according to another embodiment of the present invention. The method implements processing of a Linux thread based on a Windows system, as shown in FIG. 4, the thread processing method specifically includes following steps.

Step S21, a step of thread function conversion: converting a processing function of a Linux thread to a processing function of a corresponding Windows thread by resolving the processing function of the Linux thread.

Step S22, a step of thread data structure conversion: converting a data structure applicable to the Linux thread to a data structure applicable to the corresponding Windows thread by resolving the data structure of the Linux thread.

Step S23, a step of thread blocking management: processing blocking of a Windows thread by performing a cyclic detection on the Windows thread running in the Windows system by means of a function conversion and a data structure conversion.

Reference is made to the description of the method embodiment in FIG. 3 for the above step description, which is not repeated any more herein.

Step S24, a step of memory processing: implementing a storage function for storing the Linux thread to a Windows system memory and a search function.

Specifically, since the Windows system and the Linux system have their own storage rules, when storing the Linux thread to the Windows system memory, it is needed to find out free Windows memory space of consecutive addresses meeting the size requirements for the Linux thread and stores the Linux thread according to a Windows system memory storage rule. After the storing, there is further provided a search function, and the Linux thread is searched out from the Windows memory space according to a storage address of the Windows system memory.

When storing the Linux thread, likely the Linux thread may only need one page of the Windows memory space or need more pages of the Windows memory space. When the Linux thread needs more pages of the Windows memory space, the step of memory processing further includes executing the cross-page processing. In other words, space required for the Linux thread exceeds one page of the Windows memory space in size. When the current page space of each page of the Windows memory space is insufficient to complete storage requirements for the Linux thread, namely when the current page space in the Windows system memory is insufficient, the cross-page processing is executed according to a Windows system memory page management rule to complete memory allocation for the Windows system so as to implement the storage of the Linux thread. Meanwhile, when executing the cross-page processing, it is also needed to mark allocated memory page space. For example, a usage state (already used address space, remaining address space size and so on) of memory page space, a permission of the memory page space, address information of each memory page space, a link sequence of each memory page space and so on are marked so that it is convenient to search the Linux thread subsequently.

The step of memory processing further includes performing alignment processing to achieve memory allocation for the Windows system according to a Windows system memory alignment rule when a current byte space of the Windows system memory is insufficient. For example, when an address offset requested by the Linux thread does not meet an alignment requirement for Windows bytes, this may likely cause that, during storage, it is impossible to implement exactly one-to-one or one-to-more storage for bytes of the Windows system and bytes requested by the Linux thread, which may cause that certain space is left after a part of contents of the Linux thread is stored in the bytes of the Windows system, and the left space is insufficient to continue completing the storage of the Linux thread. In this case, the alignment processing is executed and the Windows system memory is allocated to complete the storage of the Linux thread. Meanwhile, when executing the alignment processing, it is also needed to mark allocated memory bytes. For example, a usage state (already used bytes, sizes of remaining bytes and so on) of memory bytes, a permission of the memory bytes, address information of each memory byte, a link sequence of each memory byte and so on are marked so that it is convenient to search the Linux thread subsequently.

Step S25, a step of system function conversion: converting a Linux system function to a corresponding Windows system function.

System functions used by the Linux thread are Linux system functions. When the Linux thread runs on the Windows system, it is needed to convert functions implemented by these Linux system functions to the corresponding functions of the Windows system functions. For example, the functions such as printf, strlen, fopen and so on under the Linux system are converted to the corresponding functions in win32 API under the Windows system. For example, when the Linux system functions have no corresponding Windows system functions in the Windows system, it is also needed to reconstruct the Linux system functions in the Windows system so that they are implemented as functions applicable to the Windows system.

It is to be noted that Steps S21-S25 do not have a singly restricted execution sequence. During specific execution, various steps need to be executed according to the actual situations, and the step execution sequence is not limited herein.

According to the thread processing method provided by the embodiments of the present invention, storing and searching a Linux thread on a Windows system are completed, a Linux system function is converted to a corresponding Windows system function, so that an effect of running the Linux thread on the Windows system is equivalent to that of running the Linux thread on a Linux system, thereby providing great convenience for running Andriod applications on the Windows system. An unmodified binary level compatibility to the Linux thread is implemented.

Algorithm and display provided herein are not inherently related to a particular computer, virtual system or other equipment. Various general systems may also be used with the teaching based on the present invention. According to the above description, the required structure for constructing such a system is obvious. In addition, the present invention is not directed to any particular programming language. It should be understood that a variety of programming languages can be used to implement the disclosed contents as described herein and above description to the particular programming language is to disclose the best inventive implementation mode.

Many details are discussed in the specification provided herein. However, it should be understood that the embodiments of the present invention can be implemented without these specific details. In some examples, the well-known methods, structures and technologies are not shown in detail so as to avoid an unclear understanding of the description.

Similarly, it should be understood that, in order to simplify the present invention and to facilitate the understanding of one or more of various aspects thereof, in the above description of the exemplary embodiments of the present invention, various features of the present invention may sometimes be grouped together into a single embodiment, accompanying figure or description thereof. However, the method of this present invention should not be constructed as follows: the present invention for which the protection is sought claims more features than those explicitly disclosed in each of claims. More specifically, as reflected in the following claims, the inventive aspect is in that the features therein are less than all features of a single embodiment as disclosed above. Therefore, claims following specific embodiments are definitely incorporated into the specific embodiments, wherein each of claims can be considered as a separate embodiment of the present invention.

It should be understood by those skilled in the art that modules of the device in the embodiments can be adaptively modified and arranged in one or more devices different from the embodiment. Modules, units or components in the embodiment can be combined into one module, unit or component, and also can be divided into more sub-modules, sub-units or sub-components. Except that at least some of features and/or processes or units are mutually exclusive, various combinations can be used to combine all the features disclosed in specification (including claims, abstract and accompanying figures) and all the processes or units of any methods or devices as disclosed herein. Unless otherwise definitely stated, each of features disclosed in specification (including claims, abstract and accompanying figures) may be taken place with an alternative feature having same, equivalent or similar purpose.

In addition, it should be understood by those skilled in the art, although some embodiments as discussed herein comprise some features included in other embodiment rather than other feature, combination of features in different embodiment means that the combination is within a scope of the present invention and forms the different embodiment. For example, in the claims, any one of the embodiments for which the protection is sought can be used in any combination manner.

Each of devices according to the embodiments of the present invention can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the parts in the thread processor according to the embodiments of the present invention. The present invention may further be implemented as equipment or device program (for example, computer program and computer program product) for executing some or all of the methods as described herein. Such program for implementing the present invention may be stored in the computer readable medium, or have a form of one or more signals. Such a signal may be downloaded from the Internet websites, or be provided on a carrier signal, or provided in any other form.

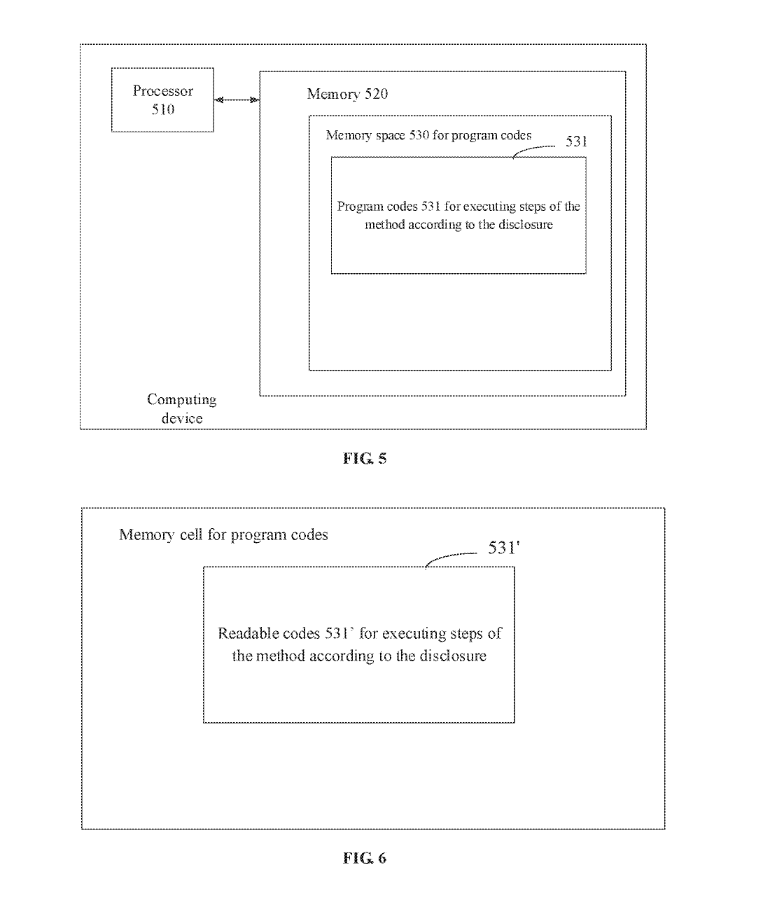

For example, FIG. 5 is a computing device for executing the thread processing method according to the present invention. Traditionally, the computing device includes a processor 510 and a program product or a readable medium in form of a memory 520. The memory 520 could be electronic memories such as flash memory, EEPROM (Electrically Erasable Programmable Read-Only Memory), EPROM or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more program products. These program products include program code carriers such as memory card. These program products are usually the portable or stable memory cells as shown in reference FIG. 6. The memory cells may be provided with memory sections, memory spaces, etc., similar to the memory 520 of the computing device as shown in FIG. 5. The program codes may be compressed for example in an appropriate form. Usually, the memory cell includes readable codes 531′ which can be read for example by processors 510. When these codes are operated on the computing device, the computing device may execute respective steps in the method as described above.

It should be noted that the above-described embodiments are intended to illustrate but not to limit the present invention, and alternative embodiments can be devised by a person skilled in the art without departing from the scope of claims as appended. In the claims, no reference mark between round brackets shall impose restriction on the claims. The word “include/comprise” does not exclude a component or step not listed in the claims. The wording “a” or “an” in front of an element does not exclude the presence of a plurality of such elements. The present invention may be realized by means of hardware comprising a number of different elements and by means of a suitably programmed computer. In the unit claim listing a plurality of devices, some of these devices may be embodied in the same hardware. The wordings “first”, “second”, and “third”, etc. do not denote any order. These wordings can be construed as naming.

1. A computing device, implementing processing of a Linux thread based on a Windows system and comprising:
a memory having instructions stored thereon;
a processor configured to execute the instructions to perform operations for implementing processing of a Linux thread based on a Windows system, the operations comprising:
converting a processing function of a Linux thread to a processing function of a corresponding Windows thread by resolving the processing function of the Linux thread;
converting a data structure applicable to the Linux thread to a data structure applicable to the corresponding Windows thread by resolving the data structure of the Linux thread; and
processing blocking of a Windows thread by performing a cyclic detection on the Windows thread running in the Windows system by means of a function conversion and a data structure conversion.

2. The computing device according to claim 1, wherein the operation of processing blocking of a Windows thread by performing a cyclic detection on the Windows thread running in the Windows system by means of a function conversion and a data structure conversion further comprises:
creating a first intermediate thread which is used for performing a cyclic detection on a Windows thread and for managing a non-blocking Windows thread to perform response processing.

3. The computing device according to claim 1, wherein the operation of processing blocking of a Windows thread by performing a cyclic detection on the Windows thread running in the Windows system by means of a function conversion and a data structure conversion further comprises:
creating a second intermediate thread which is used for performing a cyclic detection on a Windows thread, wherein when the Windows thread is blocked, the second intermediate thread suspends the Windows thread, saves blocked stack information in the Windows thread, and recovers the blocked stack information in the Windows thread after forcing the Windows thread to perform response processing.

4. The computing device according to claim 1, wherein the operation of processing blocking of a Windows thread by performing a cyclic detection on the Windows thread running in the Windows system by means of a function conversion and a data structure conversion further comprises:
detecting whether a signal on the Windows thread is invoked;
executing a related processing function corresponding to the invoked signal if the signal is invoked; otherwise
making the Windows thread be dormant for designated time.

5. The computing device according to claim 1, wherein the operations further comprise:
implementing a storage function for storing the Linux thread to a Windows system memory and a search function.

6. The computing device according to claim 5, wherein the operation of implementing a storage function for storing the Linux thread to a Windows system memory and a search function further comprises:
performing cross-page processing to achieve memory allocation for the Windows system according to a Windows system memory page management rule when a current page space of the Windows system memory is insufficient.

7. The computing device according to claim 5, wherein the operation of implementing a storage function for storing the Linux thread to a Windows system memory and a search function further comprises:
performing alignment processing to achieve memory allocation for the Windows system according to a Windows system memory alignment rule when a current byte space of the Windows system memory is insufficient.

8. The computing device according to claim 1, wherein the operation of converting a data structure applicable to the Linux thread to a data structure applicable to the corresponding Windows thread by resolving the data structure of the Linux thread further comprises:
converting a parameter data structure applicable to the Linux thread to a parameter data structure applicable to the corresponding Windows thread.

9. The computing device according to claim 1, wherein the operation of converting a data structure applicable to the Linux thread to a data structure applicable to the corresponding Windows thread by resolving the data structure of the Linux thread further comprises:
converting a thread local storage data structure applicable to the Linux thread to a thread local storage data structure applicable to the corresponding Windows thread.

10. The computing device according to claim 1, the operations further comprising:
converting a Linux system function to a corresponding Windows system function.

11. A thread processing method, implementing processing of a Linux thread based on a Windows system and comprising:
a step of thread function conversion: converting a processing function of a Linux thread to a processing function of a corresponding Windows thread by resolving the processing function of the Linux thread;
a step of thread data structure conversion: converting a data structure applicable to the Linux thread to a data structure applicable to the corresponding Windows thread by resolving the data structure of the Linux thread; and
a step of thread blocking management: processing blocking of a Windows thread by performing a cyclic detection on the Windows thread running in the Windows system by means of a function conversion and a data structure conversion.

12. The thread processing method according to claim 11, wherein the step of thread blocking management further comprises:
creating a first intermediate thread which is used for performing a cyclic detection on a Windows thread and for managing a non-blocking Windows thread to perform response processing.

13. The thread processing method according to claim 11, wherein the step of thread blocking management further comprises:
creating a second intermediate thread which is used for performing a cyclic detection on a Windows thread, wherein when the Windows thread is blocked, the second intermediate thread suspends the Windows thread, saves blocked stack information in the Windows thread, and recovers the blocked stack information in the Windows thread after forcing the Windows thread to perform response processing.

14. The thread processing method according to claim 11, wherein the step of thread blocking management further comprises:
detecting whether a signal on the Windows thread is invoked;
executing a related processing function corresponding to the invoked signal if the signal is invoked; otherwise
making the Windows thread be dormant for designated time.

15. The thread processing method according to claim 11, further comprising:
a step of memory processing: implementing a storage function for storing the Linux thread to a Windows system memory and a search function.

16. The thread processing method according to claim 15, wherein the step of memory processing further comprises:
performing cross-page processing to achieve memory allocation for the Windows system according to a Windows system memory page management rule when a current page space of the Windows system memory is insufficient.

17. The thread processing method according to claim 15, wherein the step of memory processing further comprises:
performing alignment processing to achieve memory allocation for the Windows system according to a Windows system memory alignment rule when a current byte space of the Windows system memory is insufficient.

18. The thread processing method according to claim 11, wherein the step of thread data structure conversion further comprises:
converting a parameter data structure applicable to the Linux thread to a parameter data structure applicable to the corresponding Windows thread.

19. The thread processing method according to claim 11, wherein the step of thread data structure conversion further comprises:
converting a thread local storage data structure applicable to the Linux thread to a thread local storage data structure applicable to the corresponding Windows thread.

20. The thread processing method according to claim 11, further comprising:
a step of system function conversion, converting a Linux system function to a corresponding Windows system function.

21. (canceled)

22. A non-transitory computer computer-readable medium having computer programs stored thereon that, when executed by one or more processors of a computing device, cause the computing device to perform operations for processing a Linux thread based on a Windows system, comprising:
converting a processing function of a Linux thread to a processing function of a corresponding Windows thread by resolving the processing function of the Linux thread;
converting a data structure applicable to the Linux thread to a data structure applicable to the corresponding Windows thread by resolving the data structure of the Linux thread; and
processing blocking of a Windows thread by performing a cyclic detection on the Windows thread running in the Windows system by means of a function conversion and a data structure conversion.
